(19) United States
(12) Patent Application Publication
(10) Pub. No.: US 2020/0000074 A1
(43) Pub. Date: Jan. 2, 2020

(54) LURE AND HOOK SECURING DEVICE

(71) Applicant: Brad Finney, San Clemente, CA (US)

(72) Inventor: Brad Finney, San Clemente, CA (US)

(21) Appl. No.: 16/265,958

(22) Filed: Feb. 1, 2019

Related U.S. Application Data
(60) Provisional application No. 62/625,874, filed on Feb. 2, 2018.

(51) Int. Cl. A01K 91/04

(52) U.S. Cl. CPC A01K 91/04

(57) ABSTRACT

A releasable lure and hook securing device that can safely and securely hold the fishing hook or lure close to the fishing rod when the fishing rod is not being used for fishing.

### CROSS REFERENCE TO RELATED APPLICATION

This application claims the benefit of priority, under 35 U.S.C. § 119(e), to U.S. Provisional Application No. 62/625,874, filed Feb. 2, 2018, entitled “LURE LOOPS,” the entire contents and disclosures of which are hereby incorporated by reference.

### TECHNICAL FIELD

The subject matter described herein relates generally to lure and hook securing device. More particularly, it relates to devices for holding fishing hooks and lures safely and securely to fishing rods when not used for fishing.

### BACKGROUND

Fishing is one of the most popular outdoor recreational activities in the United States. For example, more than 45.7 million Americans took at least one fishing trip in 2015. Only running and biking activities had more participants. Fishing as a hobby is generally more prevalent with older generations, but more than 60 percent of participants were under 45 in 2015. The most common form of recreational fishing is done with a rod, reel, line, hooks and any one of a wide range of baits. However, nowadays, lures are frequently used in place of bait.

A fishing lure is a type of artificial fishing bait which is designed to attract a fish's attention. The lure uses movement, vibration, flash and color to bait fish. Many lures are equipped with one or more hooks that are used to catch fish when they strike the lure. Most lures are attached to the end of a fishing line and have various styles of hooks attached to the body. During and after a fishing trip, most fishermen prefer to leave the lure on the line attached to the rod. This can be cumbersome and dangerous as the line and lure, with its one or more hooks, may swing when the rod is being handled. The movements of the lure may cause the hooks to injure someone, they will also damage the rod and the lure itself.

A need therefore exists to develop a device that can safely and securely hold the hook or lure close to the rod when the fishing rod is not being used in fishing.

### SUMMARY

Provided herein are embodiments of a releasable lure and hook securing device that can safely and securely hold a fishing hook or lure close to the fishing rod when the fishing rod is not being used for fishing. As the hook or lure is being securely held close to, or closely against, the rod, this prevents the hook or the lure and its hook(s) from damaging the rod, damaging the lure itself, or injuring someone.

In some embodiments, the releasable lure and hook securing device comprises a flexible body made of a first material and that can be releasably attached to a fishing rod, and a receiving part made of a second material and that can be attached to the flexible body for receiving a fishing hook or lure. In some embodiments, the receiving part is rigid. The receiving part may include a cylindrical shape portion providing a curving fit to an inside of a fishing hook at the bend portion, the cylindrical shape portion having a diameter sized for receiving the fishing hook when the lure and hook securing device is attached to the fishing rod.

The lure and hook securing device may be attached to the fishing rod in the proximity of the reel of the fishing rod to receive the hook or one or more hooks of the lure. In some embodiments, the lure and hook securing device may be tied or strapped to the fishing rod. As the hook or the lure hooks into a receiving part of the lure and hook securing device, tension of the fishing line can be tightened, allowing the lure and hook securing device to safely and securely hold the hook or the lure against, or close to the rod. The lure and hook securing device may advantageously have a design that requires less material and thus is cost-efficient and easy to use.

In some embodiments, the lure and hook securing device may be an elongated flexible line with a loop made with a doubled over-hand knot serving as the receiving part for receiving a hook or one or more hooks of a lure. In some embodiments, the flexible line is made of tarred-braided nylon twine with shrink-wrap.

In some embodiments, the lure and hook securing device may be an elongated flexible line with a substantially circular ring serving attached to the line as the receiving part for receiving a hook or one or more hooks of a lure.

In some other embodiments, the lure and hook securing device can be integrated with, or built into the fishing rod. The lure and hook securing device may receive a hook or one or more hooks of a lure.

In some other embodiments, a fishing rod is provided. The fishing rod may include a rod body, a reel coupled to the rod body, a rubber part coupled to the rod body adjacent to the reel, and a lure and hook securing device integrated with the rod body between the reel (the reel seat) and the rubber part, or on the rubber part and close to where the reel seat meets the rubber part. The lure and hook securing device may be made of tarred-braided nylon twine with shrink-wrap, metal, or other suitable material. As used herein, the rubber part may also be referred to as the handle of the fishing rod. The handle may be made of rubber, cork, cork tape, or other suitable material known in the art. It is the part adjacent to the reel seat toward the tip of the fishing rod. The reel seat is the location where the reel is installed on the fishing rod.

Various examples of this disclosure may describe securing a lure to the lure and hook securing device, however, hook without a lure can also be secured to the lure and hook securing device. Various examples of this disclosure may describe securing a fishing hook to the lure and hook securing device, however, the fishing hook may be part of a lure.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 illustrates an exemplary embodiment of a lure and hook securing device, in accordance with an embodiment of the present invention.

FIG. 2 illustrates an exemplary front view of the lure and hook securing device of FIG. 1 coupled to a fishing rod, in accordance with an embodiment of the present invention.

FIG. 3 illustrates an exemplary back view of the lure and hook securing device of FIG. 1 coupled to a fishing rod, in accordance with an embodiment of the present invention.

FIG. 4 illustrates an exemplary embodiment of a lure and hook securing device with a ring receiving part, in accordance with an embodiment of the present invention.

FIG. 5 illustrates exemplary view of a lure and hook securing device of FIG. 1 being used to secure a lure, in accordance with an embodiment of the present invention.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

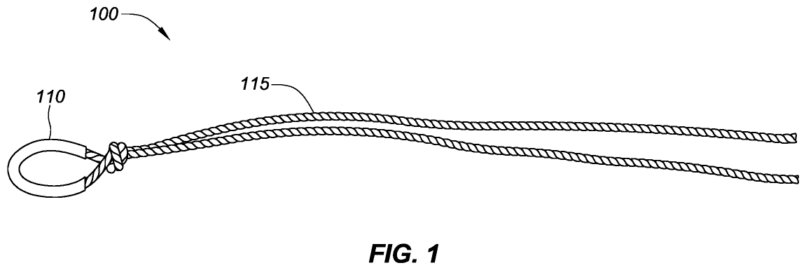

FIGS. 1-5 illustrate embodiments of releasable lure and hook securing devices that can safely and securely hold a hook or a lure against, or close to, a fishing rod when the fishing rod is not being used for fishing. As the hook or the lure is being securely held against, or close to, the rod, this prevents the hook or the lure and its hook(s) from damaging the rod, damaging the lure itself, or injuring someone. In certain embodiments, the lure and hook securing device can be releasably coupled to the fishing rod. The lure and hook securing device may include a receiving part to receive a hook or one or more hooks of the lure. As tension of the fishing line is tightened, the loop may safely and securely hold the lure against, or close to the rod. This may prevent movements of the lure that may damage the rod.

In other embodiments, the lure and hook securing device can be integrated with or built into the fishing rod.

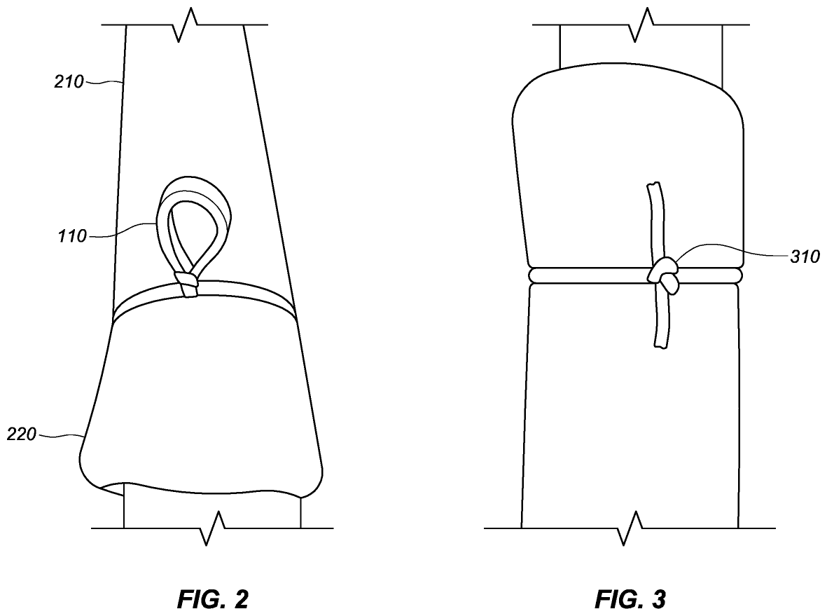

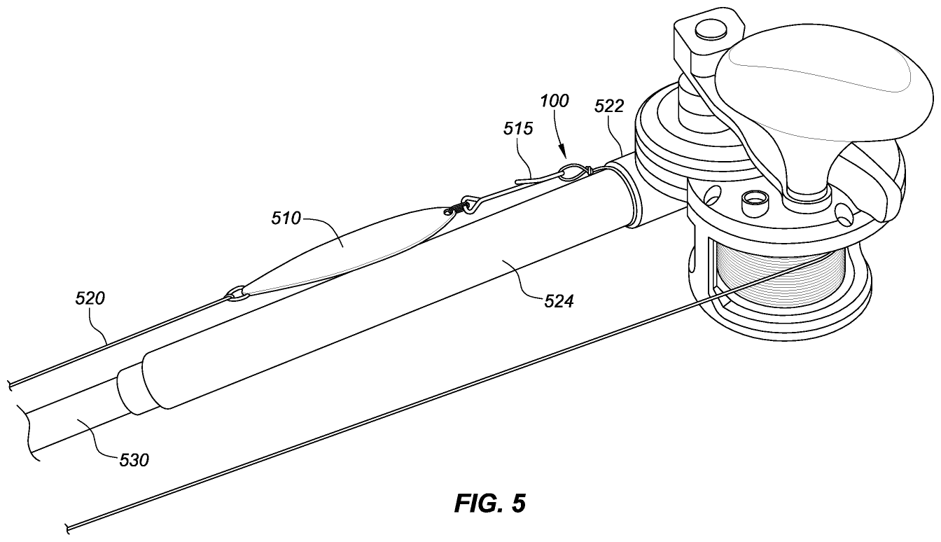

FIG. 1 illustrates an exemplary embodiment of a lure and hook securing device 100 of the present disclosure. The lure and hook securing device 100 may include a body 115 and a receiving part 110 for receiving a fishing hook. The body 115 may be made of flexible material. An advantage of using a flexible material is that it does not damage the fishing rod when attaching the lure and hook securing device 100 to a fishing rod. In some embodiments, the receiving part 110 may include a cylindrical shape portion to receive the fishing hook. The cylindrical shape may provide a curving fit of the inside of the fishing hook (at the bend portion) onto the cylindrical shape portion when the hook is hooked onto lure and hook securing device 100. The cylindrical portion has a diameter sized to receive the gape of the fishing hook (inside distance between the barb and the shank). In some embodiments, the diameter of the cylindrical portion may range approximately between 1 mm to 6 mm. The lure and hook securing device 100 may be made with flexible, tarred-braided nylon twine with shrink-wrap. Example of tarred-braided nylon twines are those made by Everson Cordage Works LLC, Everson, Wash. In some embodiments, #18 braid may be used. The receiving part 110 may be a continuous part of the flexible twine made into a loop with a doubled over-hand knot. In some embodiments, the loop 110 may have a cylindrical protective sleeve. The sleeve may be made of a strong and flexible plastic material. The sleeve may have decorative color. The lure and hook securing device 100 may be releasably attached to a fishing rod between the reel seat and the rubber part (Hypalon) (see FIG. 5), for example, by tying the two parts of the body 115 onto the rod using a figure-8 knot (see FIG. 2). Other suitable methods of securing the lure and hook securing device 100 to the rod may also be used. In some embodiments, the lure and hook securing device 100 may be releasably attached to a fishing rod on the rubber part and close to where the reel seat meets the rubber part.

The above-mentioned attachment locations of the lure and hook securing device 100 to the fishing rod provide many advantages. The location is further away from the tip of the fishing rod. When tension is made to the fishing line (after a hook or lure is hooked into the lure and hook securing device 100), the additional distance to the tip of the fishing rod allows the hook or lure to be tightly secured, providing a tight and secure fit of the lure and hook securing device 100 to the rod. Being closer to the reel, the location also provides easy and fast hooking or removing of a hook or lure to or from the lure and hook securing device 100. The location may also allow the hook or lure, after being hooked into the lure and hook securing device 100, to hover above the rubber part of the rod (see FIG. 5), such that even if there is any accidental movement of the hook or lure, either before or after tension is increased on the fishing line, the hook or lure does not damage the more expensive non-rubber part of the fishing rod.

In many applications, there exists a groove where the seat of the reel meets the rubber part. Another advantage of the lure and hook securing device 100 includes its thin and flexible body 115 which may fit securely in the groove when the lure and hook securing device 100 is attached (e.g., tied) to the rod. In this location, the lure and hook securing device 100 does not slide out of position. When the lure and hook securing device 100 is attached to the rubber part of the rod, its thin body may create an indentation or groove on the rubber, and thus may provide similar advantage.

Yet another advantage of the lure and hook securing device 100 is the soft material used.

The soft material provides a non-scratch, non-damaging attachment to the fishing rod, as there is no hard material directly coupled to the rod.

Although not shown, in some embodiments, the lure and hook securing device 100 may be fixedly integrated into the fishing rod.

FIG. 2 illustrates an exemplary front view of the lure and hook securing device 100 tied to a fishing rod, in accordance with an embodiment of the present invention. The lure and hook securing device 100 may be releasably attached to the fishing rod on the rubber part (Hypalon) 210 and close to the end 220 which is adjacent to the reel seat. As will be shown in FIG. 5, in some embodiments, the lure and hook securing device may be attached to the fishing rod between the reel seat and the rubber part.

FIG. 3 illustrates an exemplary rear view of the lure and hook securing device 100 tied to a fishing rod, in accordance with an embodiment of the present invention. The lure and hook securing device 100 may be attached to the fishing rod using a figure-8 knot 310.

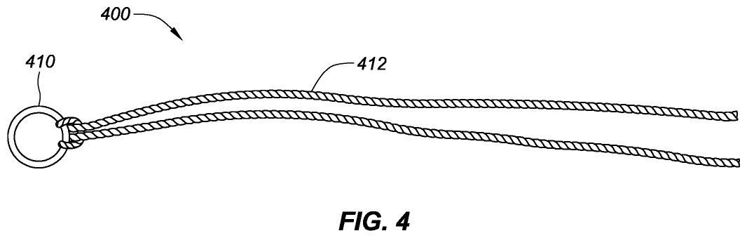

FIG. 4 illustrates exemplary embodiments of a lure and hook securing device 400. The lure and hook securing device 400 may include a body 412 and a receiving part 410 for receiving a fishing hook. The body 412 may be made of flexible material. An advantage of using a flexible material is that it does not damage the fishing rod when attaching the lure and hook securing device 400 to a fishing rod. In some embodiments, the receiving part 410 may include a cylindrical shape portion to receive the fishing hook. The cylindrical shape may provide a curving fit to the inside of the fishing hook (at the bend portion) onto the cylindrical shape portion when the hook is hooked onto lure and hook securing device 400. The cylindrical portion has a diameter sized to receive the gape of the fishing hook (inside distance between the barb and the shank). In some embodiments, the diameter of the cylindrical portion may range approximately between 1 mm to 6 mm. The lure and hook securing device 400 may have the receiving part 410 attached to the flexible body 412. In some embodiments, the receiving part 410 may be slidably attached to the body 412. In some embodiments, the receiving part 410 may be releasably attached to the body 412. In some embodiments, the receiving part 410 may have a shape of a ring. The receiving part 410 may be made of rigid material such as metal, for example, stainless-steel. In some embodiments, the receiving part 410 may be made of plastic, or any material with suitable durability for receiving a fishing hook. In some embodiments, the flexible body of the lure and hook securing device 400 may be a tarred-braided twine. In some embodiments, the receiving part 410 may be attached to the twine body 412 using a larks-head knot. Other suitable methods of securing the twine body 412 to the receiving part 410 may also be used. The lure and hook securing device 400 may be releasably attached to a fishing rod between the reel seat and the rubber part (Hypalon) (see FIG. 5), for example, by tying the two parts of the body 412 onto the rod using a figure-8 knot (see FIG. 2). Other suitable methods of securing the lure and hook securing device 400 to the rod may also be used. In some embodiments, the lure and hook securing device 400 may be releasably attached to a fishing rod on the rubber part. In some embodiments, the lure and hook securing device 400 may be releasably attached to a fishing rod on the rubber part and close to where the reel seat meets the rubber part.

Although not shown, the lure and hook securing device 400 may be fixedly integrated into the fishing rod.

FIG. 5 illustrates an exemplary view of a lure and hook securing device 100 being used to hold a lure, in accordance with an embodiment of the present invention. As shown, the lure and hook securing device 100 is releasably coupled to the fishing rod 530. The hook 515 of the lure 510 is coupled (hooked) to the lure and hook securing device 100. The line 520 is reeled in so that the tension of the fishing line 520 causes the hook 515 to be securely held by the lure and hook securing device 100 against, or close to the rod 530. As shown, the lure and hook securing device 100 is releasably attached to the fishing rod 530 between the reel seat 522 and the rubber part (Hypalon) 524. This attachment location of the lure and hook securing device 100 to the fishing rod provides many advantages as described above in reference to FIG. 1. Although not shown, in many applications, the lure and hook securing device 100 fits securely into a groove between the rubber part 524 and the reel seat 522.

In some other embodiments, the present disclosure includes a fishing rod. The fishing rod may include a rod body, a reel coupled to the rod body at a reel seat, a rubber part coupled to the rod body adjacent to the reel seat, and a lure and hook securing device integrated with the rod body between the reel seat and the rubber part, or on the rubber part but close to the reel seat. This attachment location of the lure and hook securing device to the fishing rod provides many advantages as described above in reference to FIG. 1. In some embodiments, the lure and hook securing device may be made of tarred-braided nylon twine with shrink-wrap, having a hook receiving part made of the same material, or of metal, or other suitable material.

While embodiments of the present invention have been shown and described, various modifications may be made without departing from the spirit and scope of the present invention, and all such modifications and equivalents are intended to be covered.

As used herein and in the appended claims, the singular forms “a”, “an”, and “the” include plural referents unless the context clearly dictates otherwise.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art. In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A releasable lure and hook securing device, comprising:
a flexible body made of a first material and configured to be releasably attached to a fishing rod; and
a rigid receiving part made of a second material and attached to the flexible body, wherein the receiving part comprises a cylindrical shape portion providing a curving fit to an inside of a fishing hook at a bend portion, the cylindrical shape portion having a diameter sized for receiving the fishing hook when the releasable lure and hook securing device is releasably attached to the fishing rod.

2. The releasable lure and hook securing device of claim 1, wherein the diameter of the cylindrical shape portion is greater than or equal to 1 mm and less than or equal to 6 mm.

3. The releasable lure and hook securing device of claim 1, wherein the lure and hook securing device is attached to the fishing rod between a reel seat and a rubber part of the fishing rod.

4. The releasable lure and hook securing device of claim 1, wherein the lure and hook securing device is attached to the fishing rod on a rubber part of the fishing rod.

5. The releasable lure and hook securing device of claim 1, wherein the first material is tarred-braided nylon twine with shrink-wrap.

6. The releasable lure and hook securing device of claim 1, wherein the second material is metal.

7. The releasable lure and hook securing device of claim 1, wherein the second material is plastic.

8. The releasable lure and hook securing device of claim 1, wherein the receiving part has a shape of a ring.

9. The releasable lure and hook securing device of claim 1, wherein the receiving part is attached to the flexible body using a larks-head knot.

10. The releasable lure and hook securing device of claim 1, wherein the flexible body is attached to the fishing rod using a figure-8 knot.

11. A lure and hook securing device, comprising:
a flexible body made with tarred-braided nylon twine with shrink-wrap;
a receiving part made into a loop with a doubled over-hand knot at one end of the flexible body; and
wherein the lure and hook securing device is attached to a fishing rod at at least one of between a reel seat and a rubber part, and on the rubber part close to the reel seat.

12. A lure and hook securing device, comprising:
a flexible body made with tarred-braided nylon twine with shrink-wrap;
a rigid ring-shaped receiving part attached to one end of the flexible body; and
wherein the lure and hook securing device is attached to a fishing rod at at least one of between a reel seat and a rubber part, and on the rubber part close to the reel seat.
